(19) United States
(12) Patent Application Publication
(10) Pub. No.: US 2015/0212267 A1
(43) Pub. Date: Jul. 30, 2015

(54) Optical Assembly

(71) Applicants: Tyco Electronics Nederland B.V., Ar's-Hertogenbosch (NL); Tyco Electronics Corporation, Berwyn, PA (US)

(72) Inventors: Terry Patrick Bowen, Dillsburg, PA (US); Craig Warren Hornung, Harrisburg, PA (US); Sandeep Razdan, Millbrae, CA (US); William A. Weeks, Ivyland, PA (US); Michael Tryson, Hanover, PA (US); Jibin Sun, Mountain View, CA (US); Haipeng Zhang, Santa Clara, CA (US); Jonathan Edward Lee, Harrisburg, PA (US); Michael Frank Cina, Elizabethtown, PA (US); Jeroen Antonius Maria Duis, Didam (NL)

(73) Assignees: Tyco Electronics Nederland B.V., Ar's-Hertogenbosch (NL); Tyco Electronics Corporation, Berwyn, PA (US)

(21) Appl. No.: 14/168,513

(22) Filed: Jan. 30, 2014

(51) Int. Cl. G02B 6/12; G02B 6/13; G02B 6/122

(52) U.S. Cl. CPC G02B 6/12004; G02B 6/122; G02B 6/13

(57) ABSTRACT

An optical assembly comprising: (a) a substrate having a first planar surface; (b) an optical component connected to the substrate and having a second planar surface parallel to the first surface and at least one first optical axis; (c) a plurality of optical fiber stubs having a certain diameter and being disposed at least partially between the substrate and the optical component; (d) at least one of the substrate or the optical component having one or more grooves on the first or second surfaces, respectively, such that each groove is configured to receive one of the plurality of fiber stubs such that each of the fiber stubs protrudes a first distance from the first or second surface to space the first surface the first distance from the second surface; and (e) a least one optical conduit having a second optical axis, the optical conduit being disposed on the first or second surface such that the second optical axis is optically aligned with the first optical axis.

### FIELD OF INVENTION

The subject matter herein relates generally to fiber optical assemblies, and more particularly, to an approach for aligning an optical component on a substrate of an optical assembly.

### BACKGROUND OF INVENTION

Fiber optic components are used in a wide variety of applications. The use of optical fibers as a medium for transmission of digital data (including voice, internet and IP video data) is becoming increasingly more common due to the high reliability and large bandwidth available with optical transmission systems. Fundamental to these systems are optical subassemblies for transmitting and/or receiving optical signals. As used herein, an optical assembly comprises optical, opto-electrical, and/or electrical components and provides interconnections to optically and/or electrically interconnect the optical/opto-electrical/electrical components. There is a general need to simplify both the design and manufacture of optical assemblies. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

One aspect of the invention is an optical assembly. In one embodiment, the optical assembly comprises: (a) a planar substrate having a first surface; (b) a planar optical component connected to the substrate and having a second surface parallel to the first surface and at least one first optical axis; (c) a plurality of optical fiber stubs having a certain diameter and being disposed at least partially between the substrate and the optical component; (d) at least one of the substrate or the optical component having one or more grooves on the first or second surfaces, respectively, such that each groove is configured to receive at least a portion of one of the plurality of fiber stubs such that each of the fiber stubs protrudes a first distance from the first or second surface to space the first surface the first distance from the second surface; and (e) a least one optical conduit having a second optical axis, the optical conduit being disposed on the first or second surface such that the second optical axis is optically aligned with the first optical axis.

Another aspect of the invention is a method of assembling an optical assembly having an optical component and a substrate, the substrate having a first surface, the optical component connected to the substrate and having a second surface parallel to the first surface and at least one first optical axis. In one embodiment, the method comprises: (a) disposing one or more fiber stubs on the substrate; (b) disposing the optical component over the substrate and on the fiber stubs; (c) bonding the optical component to the substrate such that the fiber stubs contact the optical component thereby spacing it from the substrate.

### BRIEF DESCRIPTION OF THE DRAWINGS

FIG. 1 shows one embodiment of the optical assembly of the present invention in which the optical fiber stub spaces an optical component from the substrate.

FIG. 2 shows the embodiment of FIG. 1 with an optical fiber optically coupled to the optical component.

FIG. 3 shows the embodiment of FIG. 1 from the top showing the stubs interspersed with the optical fibers.

FIG. 4 shows another embodiment of the optical assembly from the top with the stubs along an edge of the optical component and the optical fibers extending under the optical component.

FIG. 5 shows the embodiment of FIG. 1 from under the substrate.

FIG. 6 shows another embodiment in which the fiber stubs are at right angles to facilitate alignment along the x and y axes.

### DETAILED DESCRIPTION

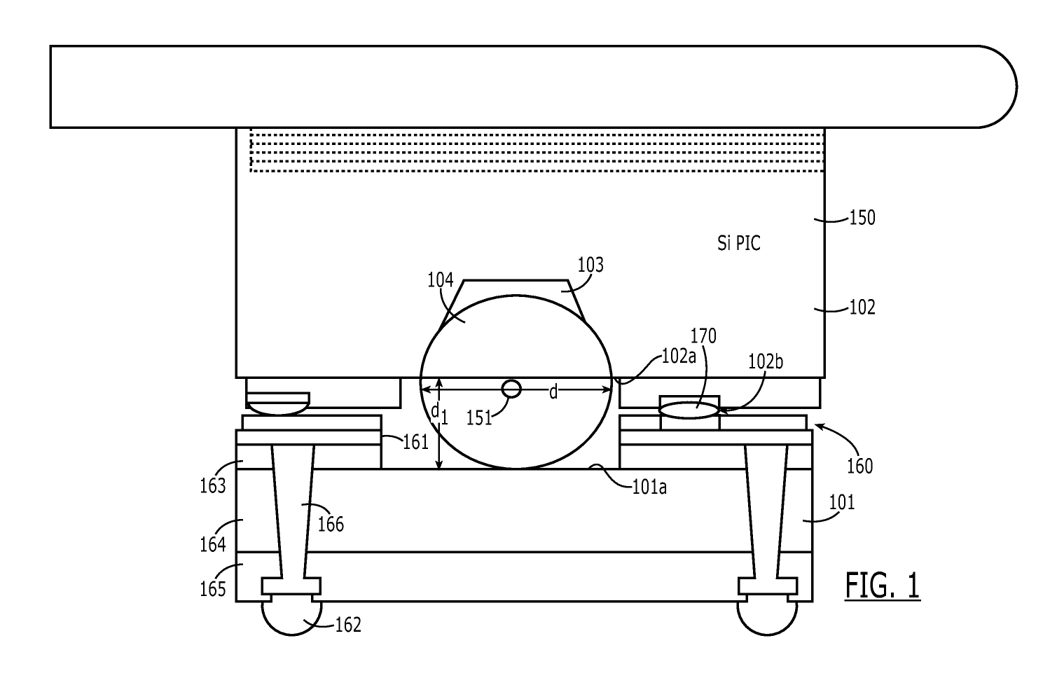

Referring to FIGS. 1-3, one embodiment of an optical assembly 100 of the present invention is shown. The optical assembly 100 comprises a planar substrate 101, having a first surface 101a, and a planar optical component 102, connected to the substrate 101, having a second surface 102a parallel to the first surface 101a, and at least one first optical axis 102b. The optical assembly also comprises a plurality of optical fiber stubs 104 having a certain diameter d and being disposed at least partially between the substrate 101 and the optical component 102. At least one of the substrate or the optical component has one or more grooves 103 on the first or second surfaces, 101a, 102a, respectively, such that each groove 103 is configured to receive one of the plurality of fiber stubs 104 such that each of the fiber stubs protrudes a first distance d1 from the first or second surface to space the first surface the first distance from the second surface. The optical assembly also comprises at least one optical conduit 105 having a second optical axis 105a, and being disposed on the first or second surface such that the second optical axis 105a is optically aligned with the first optical axis 102b. The optical assembly is described in detail below. It should be understood that the embodiment disclosed herein are merely illustrative of the invention and should not be construed as limiting the invention unless expressly indicated.

The substrate 101 serves a number of purposes. For simplicity purposes, the functionality of the substrate is described in connection with the embodiment of FIG. 1, although such functionality applies as well to the other embodiments of this disclosure. The primary purpose of the substrate is to function as the backbone of the optical assembly 100 to support, secure, align and interconnect the optical conduit 105, optical component 102, and supporting electrical circuitry. Accordingly, it should be a relatively well specified and reliable material that is thermally stable, and suitable for being heated to temperatures typical in solder reflow applications. In one embodiment, the substrate also functions as an insulator for electrical circuitry and thus should be a good dielectric. Suitable materials that are both well specified, reliable and relatively inexpensive include, for example, various types of glass, ceramics, quartz, polysilicon, amorphous silicon, and silicon. In one particular embodiment, the substrate 101 is glass, which has the benefit of being particularly well specified, inexpensive, a good dielectric, and optically transparent.

In the embodiment shown in FIGS. 1-5, the substrate 101 comprises an interface 160 for electrically connecting to the optical component 102. In this particular embodiment, the interface 160 comprises a metallic layer 161, for example, a copper layer. Disposed over the metallic layer 161 are solder balls 170 to provide electrical connection with the optical component 102. Alternatively, rather than a metallic layer 161 and solder balls 170, the interface 160 may comprise a metallic layer and copper pillars with solder balls. Still other configurations of the interface 160 will be obvious to one of skill in the art in light of this disclosure. In one embodiment, during assembly of the optical assembly 100, the solder balls electrically contact and continue to collapse in height until the fiber stubs seat into the v-grooves which align the optical axis 102b of the optical component with the optical axis 105a of the optical conduit as discussed below.

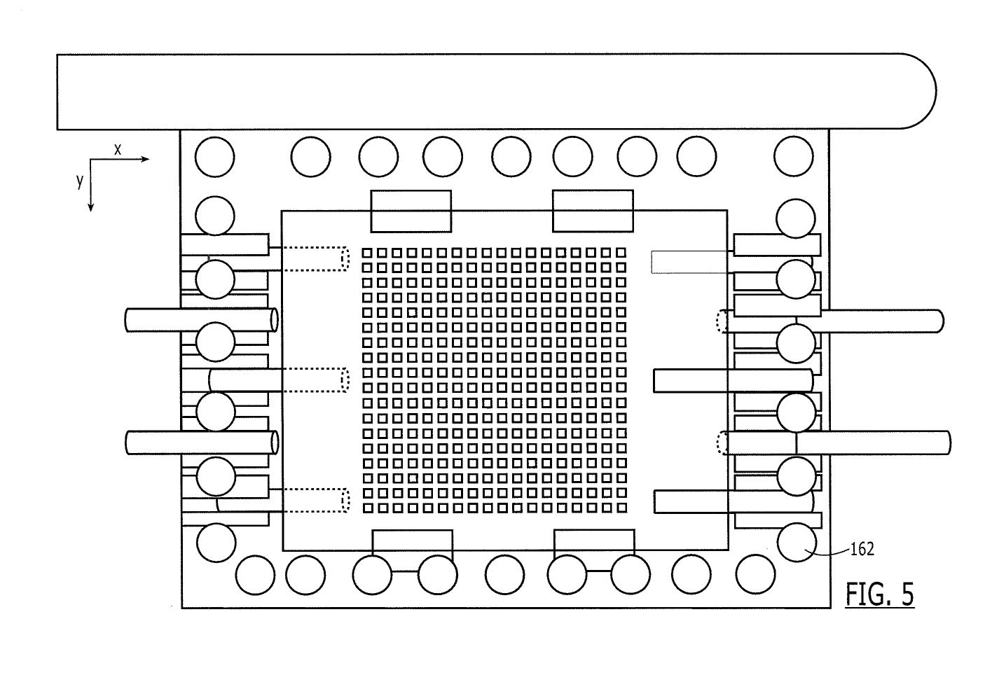

Referring to FIGS. 1 and 5, in one embodiment, portions of the metallic layer 161 may be electrically coupled to the electrical interface 162 of the optical assembly. The electrical interface 162 may be any known configuration such as, for example, pads as shown in FIG. 5, or solder balls as shown in FIG. 1. The electrical coupling may be achieved through known means such as conductive traces or vias. In the particular embodiment shown in FIG. 1, the metallic layer 161 is electrically coupled to the electrical interface 162 through a polymer layer 163, a glass layer 164, and a second polymer layer 165 using a conductive via 166. It should be understood that other configurations of the substrate 101 will be obvious to one of skill in the art in light of this disclosure.

In one embodiment, the optical assembly also comprises electrical transmit/receive integrated circuits (IC) (not shown) that are electrically connected to the optical component. The IC can be mounted either to the bottom side of the substrate 101 (e.g., between the solder balls 162), and interconnected by through vias (electrical) to top side electrical traces (not shown) that go to the optical component, or it can be mounted to the top side of the substrate 101 adjacent to the optical component and connected electrically to the optical component directly with just top side electrical traces. Electrical traces of at least 1 layer can be run on the top side or the bottom side or both for the substrate.

The optical component 102 may be any known or later-developed component that can be optically coupled to an optical conduit as described below. The optical device may be for example: (a) an optoelectric device (OED), which is an electrical device that sources, detects and/or controls light (e.g. photonics processor, such as, a CMOS photonic processor, for receiving optical signals, processing the signals and transmitting responsive signals, electro-optical memory, electro-optical random-access memory (EO-RAM) or electro-optical dynamic random-access memory (EO-DRAM), and electro-optical logic chips for managing optical memory (EO-logic chips), lasers, such as vertical cavity surface emitting laser (VCSEL), double channel, planar buried heterostructure (DC-PBH), buried crescent (BC), distributed feedback (DFB), distributed bragg reflector (DBR); light-emitting diodes (LEDs), such as surface emitting LED (SLED), edge emitting LED (ELED), super luminescent diode (SLD); and photodiodes, such as P Intrinsic N (PIN) and avalanche photodiode (APD)); (b) a passive component, which does not convert optical energy to another form and which does not change state (e.g., fiber, lens, add/drop filters, arrayed waveguide gratings (AWGs), GRIN lens, splitters/couplers, planar waveguides, or attenuators); or (c) a hybrid device which does not convert optical energy to another form but which changes state in response to a control signal (e.g., switches, modulators, attenuators, and tunable filters). It should also be understood that the optical device may be a single discrete device or it may be assembled or integrated as an array of devices. In the particular embodiment disclosed in FIGS. 1-5, the optical component is a Photonic Integrated Circuit (PIC) consisting of a large array of devices.

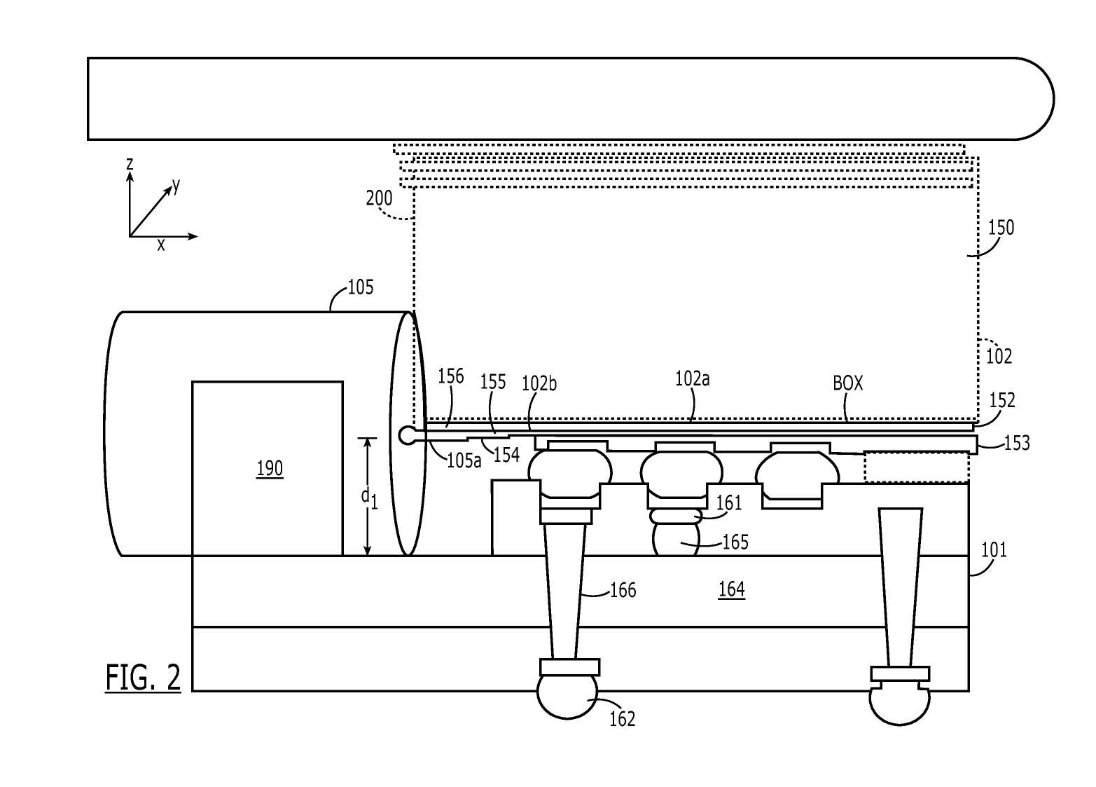

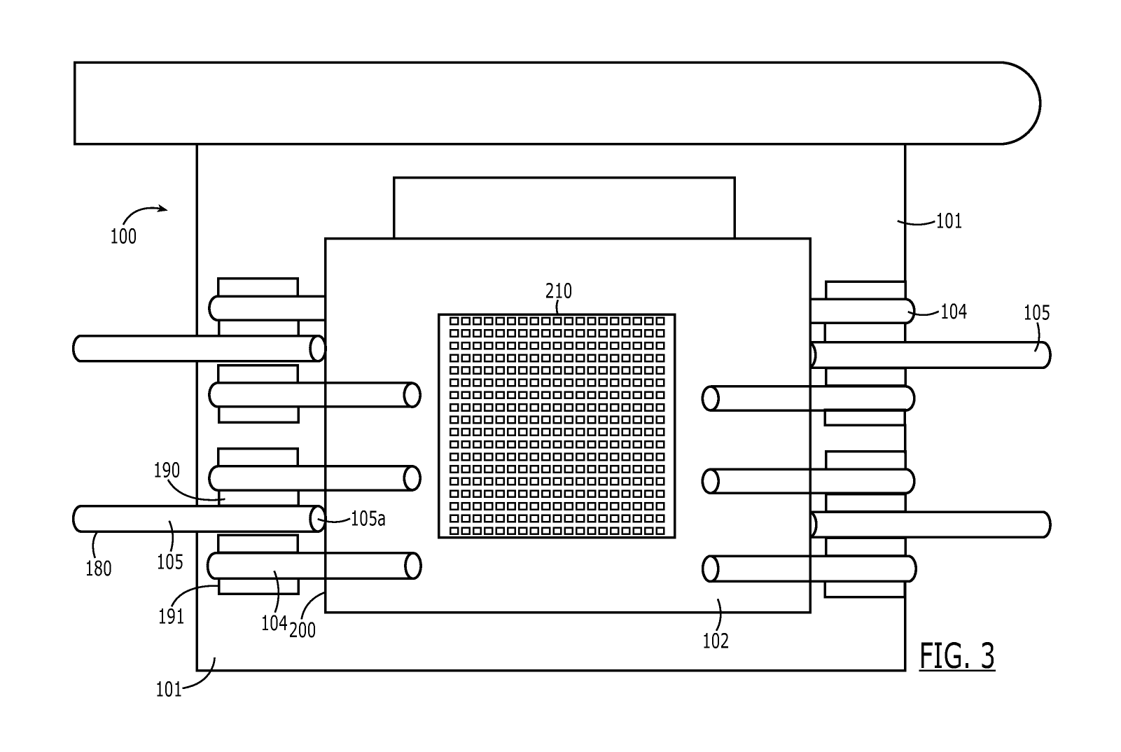

Referring to FIGS. 1-2, the optical component 102 has at least one optical axis 102b along which the light propagates in the optical component. Generally, although not necessarily, the optical axis 102a is essentially parallel to the first surface 101a. In some embodiments, it may be preferable to use an optical component having an optical axis that is essentially perpendicular to the top surface 101a. In such an embodiment, a reflective surface in the optical component or a discrete component may be used to bend the light between the optical conduit and the optical component. It should be understood that the optical component is not limited to a single optical axis and may comprise a plurality of optical axes. For example, as shown in FIG. 3, the optical component has four optical axes (not indicated), each corresponding to a discrete optical conduit 105, while the embodiment of FIG. 5 has ten optical axes (not indicated), each corresponding to a discrete optical conduit.

The optical axis of the optical component may be defined by optical waveguides within the optical component. For example, referring to FIGS. 1-2, a particular embodiment of the optical component 102 is considered in detail. The optical component 102 has a silicon substrate 150 bonded to a buried oxide (BOX) layer 152 of SiO₂ with a bonded top layer 153 of silicon. In this embodiment, the second surface 102a is the interface between the silicon substrate 150 and the BOX layer 152. In one embodiment as shown in FIG. 2, silicon waveguides 154 of the optical component 102 are formed on the second surface 102a by photolithographic patterning of the top layer of silicon 153. The center of the optical mode propagating in the waveguides 154 define the optical axis of the optical component. Additional mode matching waveguides 155, 156 may be disposed on top of the silicon waveguides 154 to adjust the mode characteristics of the silicon waveguide to more closely match the mode characteristics of the optical conduit 105. Mode matching waveguides include, for example, evanescently coupled waveguides of larger size and lower numerical aperture than the silicon waveguides 154. The center of the mode matched waveguides 155, 156 (i.e. define the new optical axis 102b) should be aligned for height with the center of the optical conduit 105 (i.e., optical axis 105a) as shown in FIG. 2. As discussed in detail below, the alignment of the optical axes 102b, 105a is achieved using fiber stubs to align the height and to align the optical component grooves with the substrate compliant guides which position the optical conduit.

An important feature of the present invention is the height spacing of the substrate 101 and the optical component 102 using optical fiber stubs. Optical fibers are know to have precise diameters. The present invention exploits this feature and uses fiber stubs as very accurate “shims” to space the optical component from the substrate. The present invention further exploits the precise diameter of the optical fiber stubs by disposing the stubs in grooves formed on the substrate and/or on the optical component. It is well known that grooves can be formed with high precision using known technologies, such as photolithography and etching. In one embodiment, the groove is a V-groove which allows the cylindrical fiber stub to seat on the angled side walls of the groove. By controlling the width of the groove at the reference surface of the substrate/optical component with high precision, the stub can be recessed precisely in the groove. Thus, the combination of the precision groove and precision stub facilitates the precise first distance d1 that the fiber stub protrudes from the first or second surfaces 101a, 102a of the substrate/optical component, respectively. The fiber stub therefore can be used to space precisely the first surface 101a from second surface 102a by the first distance d1.

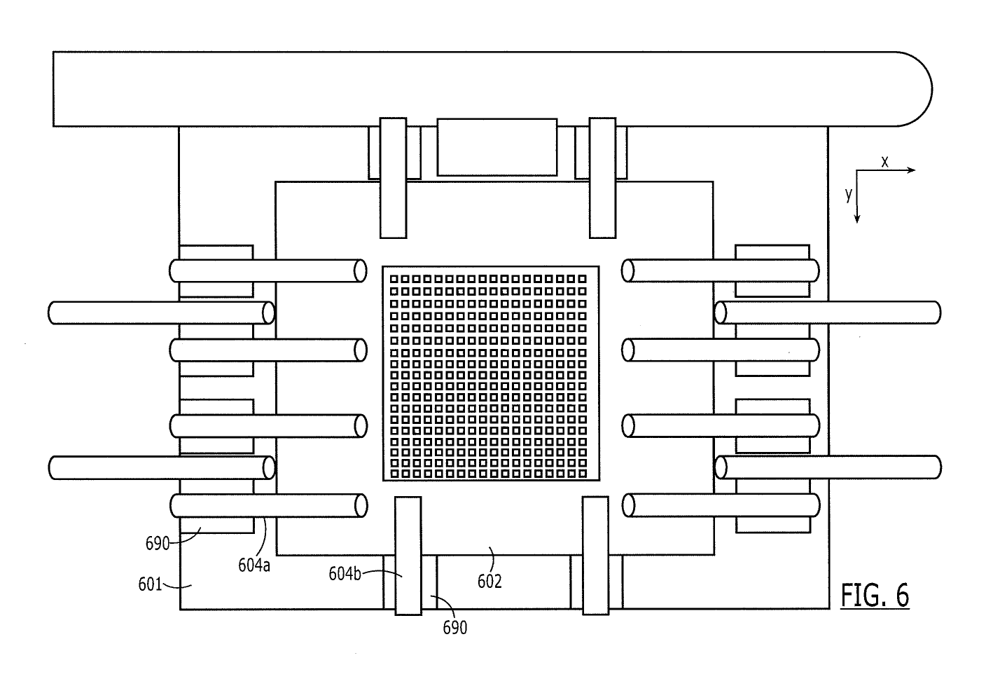

In addition to positioning the optical component from the substrate vertically or along the z axis as shown in FIG. 1, the fiber stubs and grooves can be used to position along the x and y axes as shown in FIGS. 3 and 6. In one embodiment, the fibers are used to position the substrate and optical component along the x and y axes by precisely positioning the fiber stubs on one of the two components and defining grooves in the other component. If the fiber stubs are held precisely on one of the components and are received precisely in the grooves of the other device, then the two components will be aligned precisely. Furthermore, in the embodiment shown in FIG. 6, two or more fiber stubs 604a, 604b are at right angles to align the components 601, 602 along the x and y axes. Specifically, in this embodiment, the optical component 602 defines grooves (not shown) for receiving the fiber stubs, while the substrate 601 defines compliant grips 690 for holding the stubs in register on that component. Fiber stub 604a aligns the optical component and substrate along the y-axis, while fiber stub 604b aligns the fiber stub along the x-axis. Therefore, in the embodiment of FIG. 6, the two or more fiber stubs 604a, 604b align the optical component and the substrate along the x, y and z axes.

It should be noted that although fiber stubs at right angles are used to effect alignment in FIG. 6, other embodiments are possible. For example, rather than right angle fiber stubs, fiber stubs in just on axis may be used. In such an embodiment, it may be beneficial, although not necessary, that additional alignment means be used. For example, in one embodiment, a pattern of contact pads 210 are used that passively align the optical component during a reflow operation. Specifically, the optical component 102 is provided with a certain pattern of contact pads on its bottom, the substrate 101 has the same pattern on its top planar surface. The optical component is then placed on the pads in rough alignment using known pick and place technology. Alignment between the substrate and optical component is then achieved when the assembly is reflowed such that the surface tension of the contact pads causes the patterns of the optical component to align over the pattern on the substrate, thereby precisely positioning the optical component relative to the optical conduits on the substrate. Such a mechanism is well known and disclosed for example in U.S. Pat. No. 7,511,258, incorporated herein by reference. In yet another embodiment, the pads may be directly aligned and bonded using visual recognition features by advanced pick and place technology allowing direct copper pillar to copper pillar thermocompression bonding with no solder reflow used.

In one embodiment, the grooves are etched using wet etching. Wet etching a crystalline material, such as silicon, results in a predictable and very precise etch along the crystalline planes of the material to form a V-groove. For example, silicon has a crystalline plane at 54.7°, thus, the sidewalls of a wet etched groove are formed at a precise angle of 54.7° from the reference surface. Wet etching avoids manufacturing tolerances associated with equipment setup and process steps because the crystalline plane of the substrate dictates the angle when wet etching. Additionally, as discussed below, wet etching can be performed on the wafer/panel level and its etch rate is relatively high. Therefore, wet etching offers low cost, high-volume manufacturability due to the fast speed and precision of the etch and the ability to etch at the wafer/panel level.

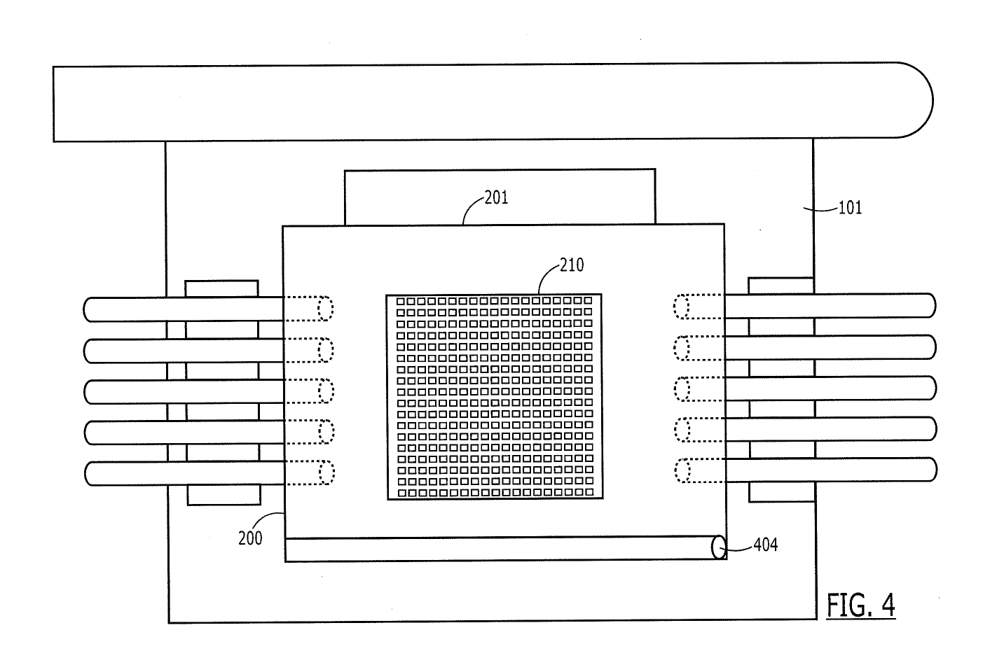

Although wet etching of the grooves has certain advantages, other approaches for forming the grooves are within the scope of this invention. For example, dry or plasma etching may be used. Alternatively, rather than etching, the grooves can be formed by mechanical means such as grinding wheel as disclosed for example in U.S. Pat. No. 7,112,872, hereby incorporated by reference. A mechanical approached may be preferred for example if the grooves for the stubs run parallel along the entire edge 201 of the optical component as shown in FIG. 4.

It should also be understood that although V-grooves are particularly well suited for seating cylindrical fiber by using the angled walls of the groove, the invention is not limited to V-grooves and may be practiced using U-grooves in which the side walls are perpendicular to the planar surfaces, or other similar configuration.

Referring to FIG. 1, one embodiment of the invention is shown in which the V-grooves 103 are etched into the optical component 102. Although not required, in one embodiment, the optical component comprises a silicon substrate 150. As mentioned above, because the silicon has a predictable crystalline plane it lends itself to wet etching. Silicon is also a well known substrate in the manufacture of optical components as described above. Therefore, the silicon substrate 150 facilitates precision v-grooves along the crystalline planes as describe above. Examples of other materials that provide predictable crystalline planes include GaAs and InP.

Referring to FIG. 1, the groove in this embodiment has a groove width of 145.1 microns. Such a width is slightly wider than the 125 micron diameter of the fiber stub such that the center 151 of the stub is slightly offset from the second surface 102a. Such an embodiment is advantageous because it establishes an optical axis plane slightly below (or above depending upon perspective) the optical component's base. This allows an optical waveguide 154 which defines the optical axis 102b to be disposed slightly below the second surface 102a as shown in FIG. 1.

In the embodiment of FIGS. 1-3, the grooves in the optical component for receiving the stubs are perpendicular to edge 200. In such an embodiment, the stubs 104 extend beyond the optical conduit 105 such that they are disposed between the substrate 101 and optical component 102 as shown in FIG. 3. It should be understood however, that other embodiments are possible. For example, in FIG. 4, the grooves are parallel to edge 201 of the optical component 102. Such a configuration facilitates wafer/panel stage manufacturing in which the stubs are disposed in the grooves and cut during the dicing of the wafer/panel. Further, such an embodiment allows more room for input/output connection along edge 200. Still other embodiments will be obvious to one of skill in the art in light of this disclosure.

In the embodiments shown in FIGS. 1-5, the fibers are received in V-grooves in the optical component and contact the substrate on its first surface 101a. In one embodiment, the fiber stubs are held in position on the first surface of the substrate by the compliant guides 191 and then the optical component is positioned over the fiber stubs such that the fiber stubs are received in the V-grooves. Various means can be used to hold the stubs in position on the substrate. For example, compliant guides 191 can be used as disclosed in U.S. Pat. No. 1,027,318, hereby incorporated by reference. In one embodiment, the compliant guides are formed on the substrate using known deposition techniques. Suitable materials for deposition include, for example, photoresists such as SU-8. Other materials will be known to those of skill in the art in light of this disclosure. Alternatively, the substrate may also comprise V-grooves to hold the fiber stubs (and optical I/O fibers) in place. In yet another embodiment, the stubs my be adhered to the substrate in their proper position. Still other embodiments will be obvious to one of skill in the art in light of this disclosure.

Although the grooves are formed in the optical component 102 in the embodiment of FIGS. 1-4, it should be understood that other configurations are possible. For example, the substrate 101 can define the grooves, while the second surface 102a of the optical component remains planar with no grooves. In such an embodiment, it might be beneficial, although not required, that the substrate comprise a crystalline material to facilitate wet etching as described above.

The optical conduit 105 may be any known medium for transmitting light. In the embodiment of FIG. 1, the optical conduit 105 is an optical fiber 180. To facilitate manufacturing, it is preferred, although not necessary that the fiber 180 have the same diameter as the fiber stub 104. The fiber 180 may be a single mode, a multimode, or a polarization-maintaining single mode fiber. The fiber may be a long fiber or it may be a pigtail for splicing or connection to a longer length of fiber. If the fiber is a pigtail it may be beneficial to use a fiber of smaller diameter. For example, commercially-available 80 micron diameter fiber may be used. Using fiber with a smaller diameter provides for more narrow grooves and less etching of the substrate surface, leaving more of the substrate top surface available for other purposes.

Although an optical fiber 180 is shown in the embodiment of FIG. 1, it should be understood that any optical conduit may be used. Suitable optical conduits include, for example, discrete fibers, ribbon fibers, and planar optical waveguides. The use of such planar optical waveguides is known and is described for example in U.S. patent application Ser. No. 13/017,668 (hereby incorporated by reference.)

In the embodiments of FIGS. 1-5, the optical conduit 105 is positioned on the substrate 101. In that particular embodiment, the optical conduit 105 is optical fiber 180 and is held in place by compliant guides 190 similar to the guides 191 for holding the fiber stubs 104 in place as shown in FIG. 3. As indicated above, other means of holding the fibers 180 in place on the substrate 101 will be obvious to one of skill in the art in light of this disclosure.

In one embodiment, to effect optical coupling between the optical conduit 105 and the optical component 102, the optical conduit 105 extends to the edge 200 of the optical component 102 at a point corresponding to an optical axis 102b as shown in FIGS. 2 and 3. In such an embodiment, it may be preferable, although not necessary, that an index matching gel/adhesive be disposed between the endface 105b of the optical conduit 105 and the edge 200 of the optical component 102. Use of such gel/adhesive tends to mitigate any surface irregularities along the edges created when the optical component is diced from a wafer/panel. A UV curable adhesive or an adhesive that can be laser written to cure can allow a coupling optical waveguide to be created between the optical conduit endface 105b and the optical axis 102b of the optical component. In another embodiment as shown in FIG. 4, the optical conduit 105 extends past the edge 200 and into a groove (not shown) defined in the second surface 102a of the optical component. If the optical conduit 105 and the stub 104 are optical fibers of the same diameter, then the grooves that receive the stub 104 may be the same width as those that receive the optical fiber 180. This is advantageous from a manufacturing standpoint as the grooves for both the stubs and fiber may be prepared in a single step.

In one embodiment, end-shaping techniques, such as those disclosed in U.S. Pat. No. 6,963,687 (hereby incorporated by reference in its entirety), may be used to shape the fiber end face with a lens or other structure to enhance optical coupling between the fiber 180 and the optical component 102. For example, for a single mode fiber with an air gap between the fiber 180 and optical component 102, a slant or angle finish of the fiber end face will reduce back reflection.

The optical assembly of the present invention also lends itself to economical and highly repeatable manufacturing. In one embodiment, a significant portion of the preparation of the assembly is performed at the wafer/panel stage. That is, rather than preparing each assembly as a discrete component, multiple assemblies can be prepared simultaneously on a wafer/panel. This is a known technique to facilitate large-scale manufacturability. Benefits of wafer/panel fabrication include the ability to define multiple features and components on multiple optical assemblies in one step. For example, most if not all of the critical alignment relationships may be defined on the wafer/panel scale, often in just a few, or even a single, photolithography step. Specifically, the location of the grooves, compliant guides for holding the fiber and fiber stubs and the contact pads/pillars for electrically connecting and providing passive alignment of the optical components may be defined in a single masking step. Additionally, in one embodiment, the optical/electrical interconnections among the various components may be defined in a single masking step. For example, the various traces interconnecting the pads/pillars for the optical component and the pads for the electrical driver circuitry, and the traces between the driver circuitry and the through substrate vias may be defined in a single masking step. In one embodiment, even the edges of the optical component and substrate are defined in the same masking step. For example, each edge of the optical component is one half of a groove etched in the wafer/panel. The wafer/panel is simply parted at the bottom of each groove to form optical components with precisely controlled edges. This way, the distance from the edge of the optical component to critical features may be precisely controlled, often in a single step, thereby eliminating tolerance build up and simplifying assembly manufacturing with the optical component by use of these precisely controlled edges. These advantages are expected to increase as the size of wafer/panels and their handling capabilities increase as well. Further economies may be realized by etching these features using the same photolithographic procedure. Although a single etching procedure may be used, in certain circumstances, two or more etching procedures may be beneficial.

While this description is made with reference to exemplary embodiments, it will be understood by those skilled in the art that various changes may be made and equivalents may be substituted for elements thereof without departing from the scope. In addition, many modifications may be made to adapt a particular situation or material to the teachings hereof without departing from the essential scope. Also, in the drawings and the description, there have been disclosed exemplary embodiments and, although specific terms may have been employed, they are unless otherwise stated used in a generic and descriptive sense only and not for purposes of limitation, the scope of the claims therefore not being so limited. Moreover, one skilled in the art will appreciate that certain steps of the methods discussed herein may be sequenced in alternative order or steps may be combined. Therefore, it is intended that the appended claims not be limited to the particular embodiment disclosed herein.

What is claimed is:

1. An optical assembly comprising:
a substrate having a first planar surface;
an optical component connected to said substrate and having a second planar surface parallel to said first surface and at least one first optical axis;
a plurality of optical fiber stubs having a certain diameter and being disposed at least partially between said substrate and said optical component;
at least one of said substrate or said optical component having one or more grooves on said first or second surfaces, respectively, such that each groove is configured to receive one of said plurality of fiber stubs such that each of said fiber stubs protrudes a first distance from said first or second surface to space said first surface said first distance from said second surface; and
a least one optical conduit having a second optical axis, said optical conduit being disposed on said first or second surface such that said second optical axis is optically aligned with said first optical axis.

2. The optical assembly of claim 1, wherein said substrate comprises glass.

3. The optical assembly of claim 1, wherein said substrate is electrically connected to said optical component.

4. The optical assembly of claim 3, further comprising solder interconnection between said substrate and said optical component.

5. The optical assembly of claim 4, wherein said substrate comprises one or more layers disposed on said first surface.

6. The optical assembly of claim 5, wherein said one or more layers comprise a metallic layer for communicating signals/electrical power to and from said optical component.

7. The optical assembly of claim 3, wherein said electrical interconnection comprises metallic pillars.

8. The optical assembly of claim 3, wherein the electrical interconnection comprises metallic pillars with solder caps.

9. The optical assembly of claim 1, wherein said substrate comprises guides to hold said optical fiber stubs in place on said substrate.

10. The optical assembly of claim 9, wherein said guides are complaint

11. The optical assembly of claim 1, wherein said optical conduit is an optical fiber.

12. The optical assembly of claim 11, wherein said substrate comprises guides to hold said optical fiber stubs and said optical fiber in place on said substrate.

13. The optical assembly of claim 12, wherein said optical fiber stubs and said optical fiber are held in parallel.

14. The optical assembly of claim 11, wherein said optical fiber has said certain diameter.

15. The optical assembly of claim 1, wherein said at least one optical conduit comprises a plurality of optical conduits.

16. The optical assembly of claim 1, wherein said optical component has said grooves on said second surface.

17. The optical assembly of claim 16, wherein said grooves are wet-etched.

18. The optical assembly of claim 17, wherein said optical component comprises silicon and said wet-etch creates a groove along the crystalline planes of said silicon.

19. A method of manufacturing an optical assembly having an optical component and a substrate, said substrate having a first surface, said optical component connected to said substrate and having a second surface parallel to said first surface and at least one first optical axis, said method comprising:
disposing one or more fiber stubs on said substrate;
disposing said optical component over said fiber stubs on said substrate; and
bonding said optical component to said substrate such that said fiber stubs contact said optical component thereby spacing it from said substrate.

20. The method of claim 19, wherein said bonding comprises reflowing solder pads between said optical component and said substrate thereby causing said optical component and said substrate to be drawn together.

21. The method of claim 19, wherein said bonding is thermocompression bonding.

22. The method of claim 21, wherein said thermocompression bonding comprises thermocompression bonding metallic pillar to metallic pillar such that said fiber stubs contact said optical component thereby spacing it from said substrate.

23. The method of claim 21, wherein said thermocompression bonding comprises thermocompression bonding a metallic pillar with solder cap to a metallic pillar with solder cap such that said fiber stubs contact said optical component thereby spacing it from said substrate.

24. The method of claim 21, wherein said thermocompression bonding comprises thermocompression bonding a metallic pillar with solder cap to metallic bonding pad such that said fiber stubs contact said optical component thereby spacing it from said substrate.

25. The method of claim 19, further comprising:
positioning at least one optical conduit on said substrate relative to said optical component such that an optical axis of said optical conduit is aligned with said first optical axis.

26. The method of claim 25, further comprising:
disposing between said optical conduit and said optical component an adhesive to enhance optical coupling therebetween.

27. The method of claim 26, further comprising:
optically writing a coupling optical waveguide between said first optical axis of said optical component and said optical axis of the optical conduit.
